(19) United States
(12) Patent Application Publication
(10) Pub. No.: US 2026/0077806 A1
(43) Pub. Date: Mar. 19, 2026

(54) PLANETARY BELT DRIVE SYSTEM FOR TORQUE OVERLAY

(71) Applicant: ZF CV Systems Global GmbH, Bern (CH)

(72) Inventors: Praful BARI, West Lafayette, IN (US); Joseph HARTER, Yorktown, IN (US)

(21) Appl. No.: 18/889,455

(22) Filed: Sep. 19, 2024

(51) Int. Cl. B62D 5/04

(52) U.S. Cl. CPC B62D 5/0403; B62D 5/0424

(57) ABSTRACT

A system for rotating a steering shaft of a vehicle, the steering shaft extending in a longitudinal direction, includes: a planetary gear set including: a sun gear, a ring gear disposed radially outward in a radial direction with respect to the sun gear, and a planetary carrier comprising a plurality of planetary gears and a planetary carrier output shaft, each planetary gear of the plurality of planetary gears being rotatable within the planetary carrier, in radially outward rotating engagement with the ring gear, and in radially inward rotating engagement with the sun gear; a belt drive system including: a planetary carrier output shaft pulley concentrically disposed on the planetary carrier output shaft, a steering shaft pulley disposed radially adjacent to the planetary carrier output shaft pulley, and a pulley belt disposed at least partially around the planetary carrier output shaft pulley and at least partially around the steering shaft pulley.

### TECHNICAL FIELD

The present disclosure generally relates to systems and methods that facilitate rotation of a steering shaft of a vehicle's steering system.

### BACKGROUND

The advent of automated driver assistance systems (“ADAS”) has resulted in the need to modify conventional hydraulic steering systems of vehicles to include an electric motor to facilitate steering, both automated and non-automated, of the vehicle. Incorporation of the electric motor into a hydraulic steering system provides various benefits, including easier steering efforts while the vehicle is both in motion and stationary, smooth handling and adaptive steering feel from low to high speeds, consistent steering experience independent of road conditions, excellent reversibility from any turn angle at any vehicle speed while driving forward and backward, and cross-wind and road crown compensation, among others.

Such electric motors are typically mechanically positioned between the steering shaft, which is controlled by the operator of the vehicle through a steering wheel, and the steering gear, which converts the steering commands inputted by the driver through the steering wheel into steering outputs that move the steering wheels of the vehicle. By positioning the electric motor in this manner, the electric motor facilitates steering operations of the vehicle. Addition of an electric motor to a hydraulic steering system greatly expands the ability to control the steering of the vehicle, and can convert the hydraulic steering system into a “smart”steering system.

There is a need, however, to develop solutions for more easily integrating electric motors into hydraulic steering systems, particularly in the commercial vehicle environment. Such solutions must incorporate electric motors that can provide the requisite torque to assist in rotation of the steering shaft, yet still meet specific packaging requirements.

### SUMMARY

One aspect of the present disclosure is directed to a system for rotating a steering shaft of a vehicle, the steering shaft extending in a longitudinal direction, the system comprising: a planetary gear set comprising: a sun gear, a ring gear disposed radially outward in a radial direction with respect to the sun gear, and a planetary carrier comprising a plurality of planetary gears and a planetary carrier output shaft, each planetary gear of the plurality of planetary gears being rotatable within the planetary carrier, in radially outward rotating engagement with the ring gear, and in radially inward rotating engagement with the sun gear; and a belt drive system comprising: a planetary carrier output shaft pulley concentrically disposed on the planetary carrier output shaft, a steering shaft pulley disposed radially adjacent to the planetary carrier output shaft pulley, and a pulley belt disposed at least partially around the planetary carrier output shaft pulley and at least partially around the steering shaft pulley, wherein the steering shaft pulley is concentrically disposable on the steering shaft.

Another aspect of the present disclosure is directed to a method of applying a steering shaft torque to a steering shaft of a vehicle, the method comprising: generating an output shaft torque at an output shaft of an electric motor; rotating, with the output shaft torque, a plurality of planetary gears of a planetary carrier, the planetary carrier comprising a planetary carrier output shaft pulley, with a pulley belt being disposed at least partially around the planetary carrier output shaft pulley; rotating the planetary carrier within a ring gear through rotating engagement between the plurality of planetary gears and the ring gear so as to rotate the planetary carrier output shaft pulley and generate a movement of the pulley belt; and rotating a steering shaft pulley disposed on the steering shaft through the movement of the pulley belt so as to generate the steering shaft torque.

### BRIEF DESCRIPTION OF THE DRAWINGS

FIG. 1 shows an exploded view of a system for rotating a steering shaft of a vehicle according to the present disclosure;

FIG. 2A and FIG. 2B show two perspective views of the system of FIG. 1, with an enclosure shown in dashed lines;

FIG. 3A and FIG. 3B show the system of FIG. 1 without an enclosure and with an enclosure, respectively;

FIG. 4A and FIG. 4B show detailed views of a planetary gear set and belt drive system, respectively, of the system of FIG. 1;

FIG. 5 shows a side view of the system of FIG. 1;

FIG. 6 shows the system of FIG. 1 in a vehicle;

FIG. 7 shows a column assembly of a vehicle to which the system of FIG. 1 is attached;

FIG. 8 shows a firewall of a vehicle to which the system of FIG. 1 is to be mounted;

FIG. 9 shows a view of the system of FIG. 1 mounted to a firewall of a vehicle;

FIG. 10 shows another view of the system of FIG. 1 mounted to a firewall of a vehicle;

FIG. 11A and FIG. 11B show the system of FIG. 1 mounted to a firewall of a vehicle and covered by a covering; and

FIG. 12A and FIG. 12B show the system of FIG. 1 mounted to a firewall of a vehicle and covered by a covering, with a steering wheel of the vehicle attached to the steering column.

### DETAILED DESCRIPTION

The systems and methods described herein overcome the problems of the prior art by providing a torque overlay mechanism that enhances the power steering experience in commercial vehicles. The torque overlay mechanism provides a steering shaft torque to the steering shaft of the vehicle. By applying a steering shaft torque to the steering shaft, the systems and methods described herein improve driver comfort and reduce driver effort, especially under high axle loads. At the same time, the systems and methods described herein meet the space requirements existing within commercial vehicles, including the space requirements dictated by the relative positioning of the brake and clutch pedals, the firewall, and the steering column.

The systems and methods described herein employ a planetary gear set in conjunction with a belt drive system to provide a steering shaft torque. The planetary gear set provides robust torque multiplication, while the belt drive system ensures quiet operation and damping characteristics. Together, the planetary gear set and belt drive system meet the torque and RPM requirements of the steering shaft, resulting in a smooth and responsive steering experience.

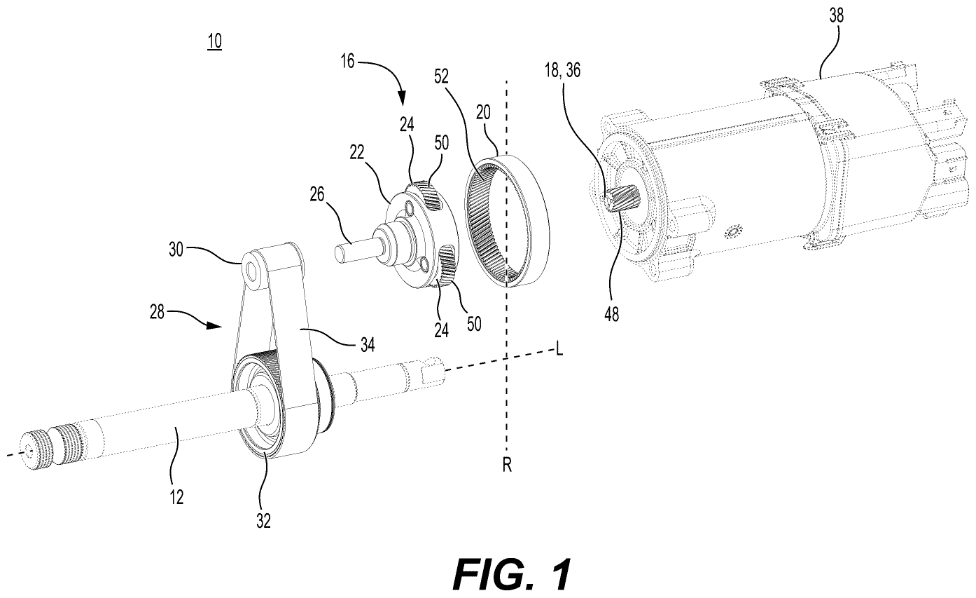

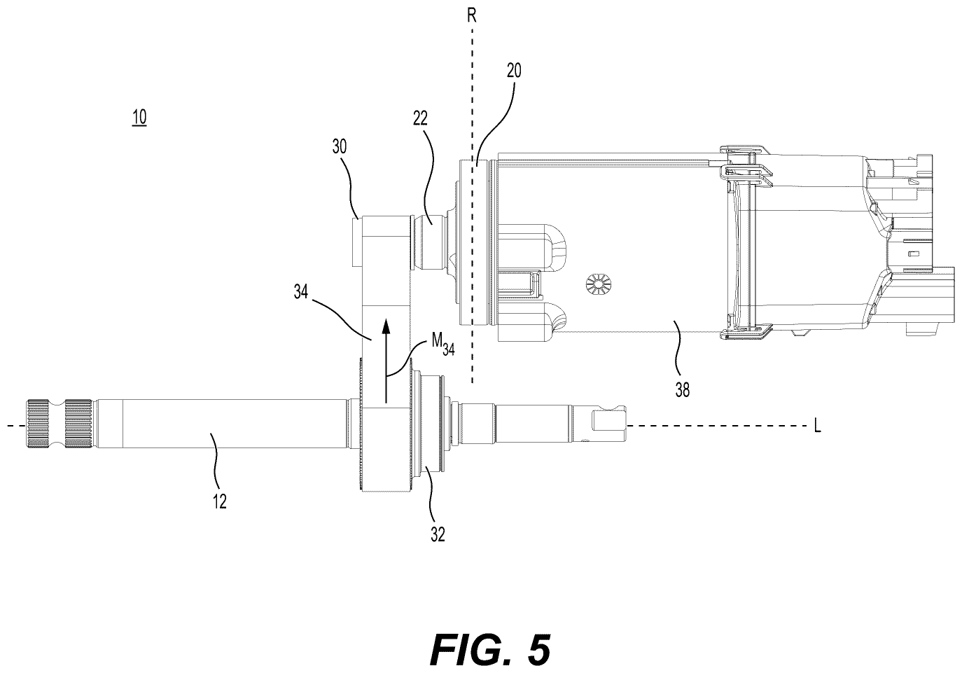

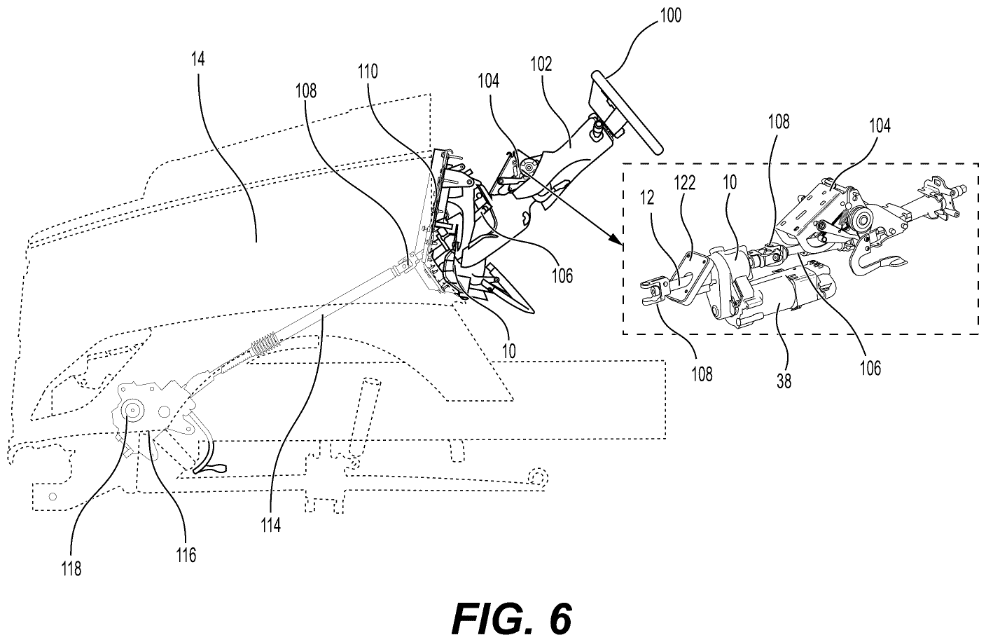

FIG. 1-5 show various aspects of a system 10 for rotating a steering shaft 12 of a vehicle 14 (which vehicle 14 is shown in FIG. 6). The steering shaft 12 extends in a longitudinal direction L. System 10 may include a planetary gear set 16 and a belt drive system 28.

The planetary gear set 16 may include a sun gear 18, a ring gear 20 disposed radially outward in a radial direction R with respect to the sun gear 18, and a planetary carrier 22. The planetary carrier 22 may include a plurality of planetary gears 24. Each planetary gear 24 of the plurality of planetary gears 24 is rotatable within the planetary carrier 22. Furthermore, each planetary gear 24 is in radially outward rotating engagement with the ring gear 20, and in radially inward rotating engagement with the sun gear 18. As such, planetary gears 24 are positioned between sun gear 18 and ring gear 20, and in rotating engagement with both sun gear 18 and ring gear 20.

The rotating engagement between planetary gears 24 and each of sun gear 18 and ring gear 20 is facilitated by various teeth on those gears. More particularly, sun gear 18 may include a plurality of sun gear teeth 48 facing in a radially outward direction with respect to sun gear 18. Each planetary gear 24 may include plurality of planetary gear teeth 50, which planetary gear teeth 50 also face in a radially outward direction with respect to each respective planetary gear 24. At least some of planetary gear teeth 50 of each planetary gear 24 are in rotating engagement with at least some sun gear teeth 48 of sun gear 18, such that each planetary gear 24 may rotate (i.e., within planetary carrier 22) with respect to sun gear 18. Ring gear 20 also may include a plurality of ring gear teeth 52, which ring gear teeth 52 face in a radially inward direction with respect to ring gear 20. At least some planetary gear teeth 50 of each planetary gear 24 are in rotating engagement with at least some ring gear teeth 52 of ring gear 20, such that each planetary gear 24 may rotate (i.e., within planetary carrier 22) with respect to ring gear 20.

In the embodiment shown, the planetary gear set 16 includes three planetary gears 24, but other numbers of planetary gears 24 are possible and within the scope of the present application.

Planetary carrier 22 may also include a planetary carrier output shaft 26, which is fixed with respect to planetary carrier 22. In this manner, rotation of planetary carrier 22 (vis-à-vis rotation of planetary gears 24) rotates planetary carrier output shaft 26. In an embodiment, the planetary gear set 16 may have a planetary gear set ratio φ₁₆ of approximately 6:1, meaning that for every six (6) turns of sun gear 18, planetary carrier output shaft 26 turns approximately one (1) time.

“Approximately” in the context of the present application means “in the range of,” such that a planetary gear set ratio φ₁₆ of 5.8:1 would be a planetary gear set ratio φ₁₆ of approximately 6:1. Similarly, a planetary gear set ratio φ₁₆ of 6.4:1 would also be a planetary gear set ratio φ₁₆ of approximately 6:1. In general, however, the planetary gear set ratio φ₁₆ of could be from approximately 4:1 to 8:1.

System 10 may also include belt drive system 28. Belt drive system 28 may include a planetary carrier output shaft pulley 30 concentrically disposed on the planetary carrier output shaft 26, and a steering shaft pulley 32 disposed radially adjacent to the planetary carrier output shaft pulley 30.

Planetary carrier output shaft pulley 30 is connected to steering shaft pulley 32 (i.e., as to be able to transfer rotation of planetary carrier output shaft pulley 30 to steering shaft pulley 32) by a pulley belt 34. In particular, pulley belt 34 is disposed at least partially around the planetary carrier output shaft pulley 30 and at least partially around the steering shaft pulley 32. Steering shaft pulley 32, in turn, is concentrically disposable on the steering shaft 12 so as to translate rotation of steering shaft pulley 32 into rotation of steering shaft 12 (e.g., by applying a steering shaft torque τ₁₂ on steering shaft 12).

In an embodiment, belt drive system 28 may have a belt drive system ratio φ₂₈ of approximately 3:1, meaning that for every three (3) turns of planetary carrier output shaft pulley 30, steering shaft pulley 32 turns approximately one (1) time. As noted above, “approximately” in the context of the present application means “in the range of,” such that a belt drive system ratio φ₂₈ of 2.7:1 would be a belt drive system ratio φ₂₈ of approximately 3:1. Similarly, a belt drive system ratio φ₂₈ of 3.4:1 would also be a belt drive system ratio φ₂₈ of approximately 3:1. In general, however, the belt drive system ratio φ₂₈ of could be from approximately 1.5:1 to 5:1.

In an embodiment, the planetary gear set 16 has a planetary gear set ratio φ₁₆ of approximately 6:1 and the belt drive system 28 has a belt drive system ratio φ₂₈ of approximately 3:1, such that a system ratio φ₁₀ of the system 10 is approximately 18:1. Such a system ratio φ₁₀ meets the torque and RPM requirement for rotating the steering shaft 12 as needed, while also allowing the electric motor 38 to rotate at a higher RPM to achieve ideal performance of the electric motor 38 (e.g., 1,500-1,800 RPM). In an embodiment, the steering shaft torque τ₁₂ output by system 10 ranges from 10 N·m to 20 N·m.

In an embodiment, a planetary carrier output shaft pulley diameter D₃₀ of the planetary carrier output shaft pulley 30 is less than a steering shaft pulley diameter D₃₂ of the steering shaft pulley 32. For example, planetary carrier output shaft pulley diameter D₃₀ may be 25 mm, while steering shaft pulley diameter D₃₂ may be 68.25 mm. Varying planetary carrier output shaft pulley diameter D₃₀ of planetary carrier output shaft pulley 30 and steering shaft pulley diameter D₃₂ of steering shaft pulley 32 with respect to one another allows for changing belt drive system ratio φ₂₈, and ultimately system ratio φ₁₀.

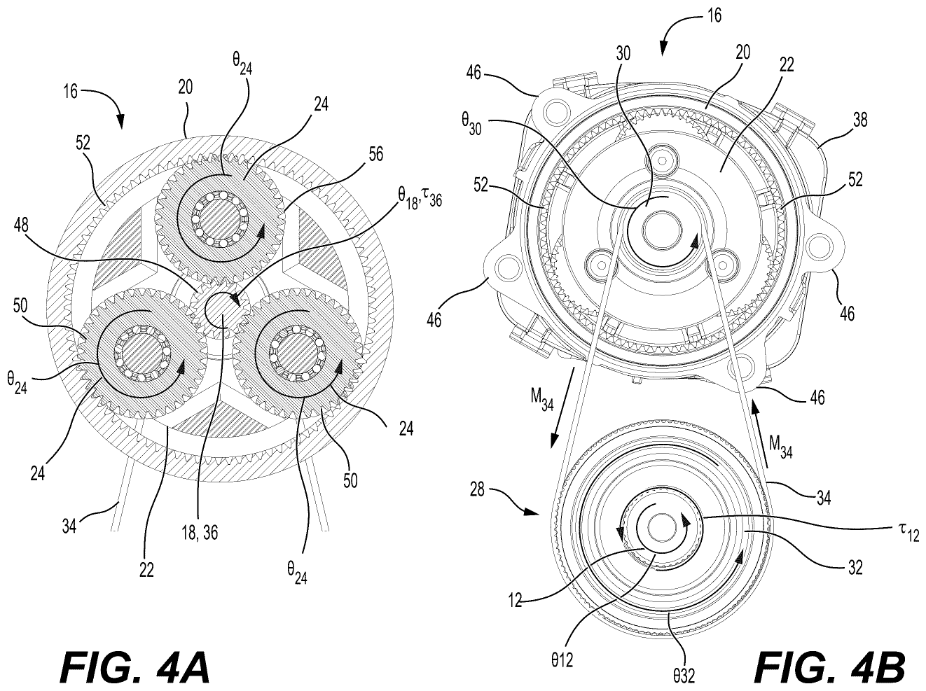

As shown in more detail in FIG. 4A-4B, rotation of one component of system 10 may result in rotation of one or more other components of system 10. For example, a rotation of the sun gear 18 (θ₁₈) may rotate the plurality of planetary gears 24 (θ₂₄). In turn, rotation of planetary gears 24 (θ₂₄) may rotate planetary carrier output shaft pulley 30 (θ₃₀). Furthermore, a rotation of the planetary carrier output shaft pulley 30 (θ₃₀) may rotate steering shaft pulley 32 (θ₃₂). In this manner, rotation of the sun gear 18 (θ₁₈) (e.g., by electric motor 38) can result in a rotation of the steering shaft pulley 32 (θ₃₂), and since steering shaft pulley 32 may be disposed on steering shaft 12, a steering shaft torque τ₁₂ may thus be applied to steering shaft 12. System 10 may therefore be used to control a rotation of steering shaft 12 (θ₁₂) (e.g., to implement one more ADAS functions).

In an embodiment, sun gear 18 may be the output shaft 36 of electric motor 38. It is also possible, however, that system 10 includes a sun gear 18 that is distinct from output shaft 36 of electric motor 38, in which case output shaft 36 would need to be removed from electric motor 38 and sun gear 18 attached in its place in order for sun gear 18 to facilitate rotation and movement within system 10.

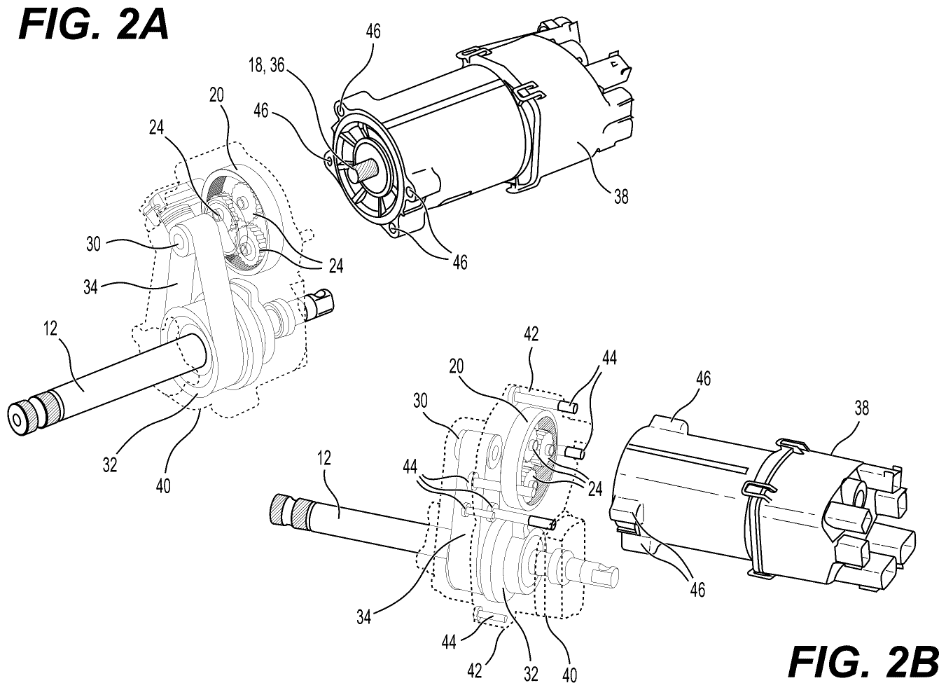

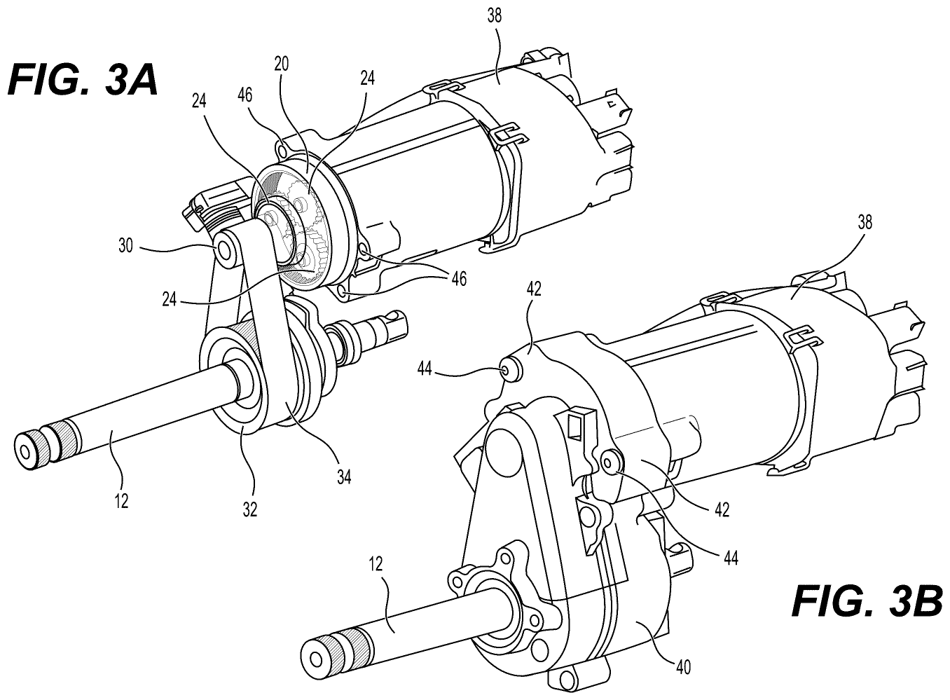

As shown in more detail in FIG. 2A-2B and 3B, system 10 may include an enclosure 40. Enclosure 40 may provide covering and/or protection for the components of system 10, such as planetary gear set 16 and belt drive system 28. Enclosure 40 may include a plurality of enclosure fastening guides 42. Electric motor 38, in turn, may include a plurality of electric motor fastener guides 46 that align with the plurality of enclosure fastening guides 42 of enclosure 40. Enclosure 40 may thus be secured to electric motor 38 using a plurality of fasteners 44. For example, a fastener 44 may be disposed in a respective enclosure fastening guide 42 of enclosure 40 and in a respective electric motor fastener guide 46 of electric motor 38. Repeating this process with multiple fasteners 44 will secure enclosure 40 to electric motor 38.

As discussed herein, system 10 can be used to apply a steering shaft torque τ₁₂ to steering shaft 12. The method may include generating an output shaft torque τ₃₆ at output shaft 36 of electric motor 38, or at sun gear 18, through rotation of output shaft 36 or sun gear 18 (θ₁₈). Output shaft torque τ₃₆ may then cause rotation of planetary gears 24 (θ₂₄). Rotation of planetary gears 24 (θ₂₄), in turn, may result in the rotation of planetary carrier 22 (θ₂₂) within ring gear 20. Such rotation (θ₂₂) may occur as a result of rotating engagement between planetary gears 24 and ring gear 20. Rotation of planetary carrier 22 (θ₂₂), in turn, may rotate planetary carrier output shaft pulley 30 (θ₃₀), which may be disposed on planetary carrier output shaft 26 of planetary carrier 22. Rotation of planetary carrier output shaft pulley 30 (θ₃₀) generates a movement of pulley belt 34 (M₃₄). Movement of pulley belt 34 (M₃₄), in turn, causes rotation of steering shaft pulley 32 (θ₃₂), and since steering shaft pulley 32 is disposed on steering shaft 12, rotation of steering shaft pulley 32 (θ₃₂) generates steering shaft torque τ₁₂ on steering shaft 12.

In an embodiment, output shaft 36 of electric motor 38 is approximately parallel with the steering shaft 12. Positioning electric motor 38 in this manner allows the system 10 to meet certain packaging requirements within vehicle 14. For example, if output shaft 36 of electric motor 38 is approximately parallel with the steering shaft 12, system 10 may be positioned within the steering column of vehicle 14. If electric motor 38 were positioned in another way with respect to steering shaft 12, it may not be possible to place system 10 in the steering column.

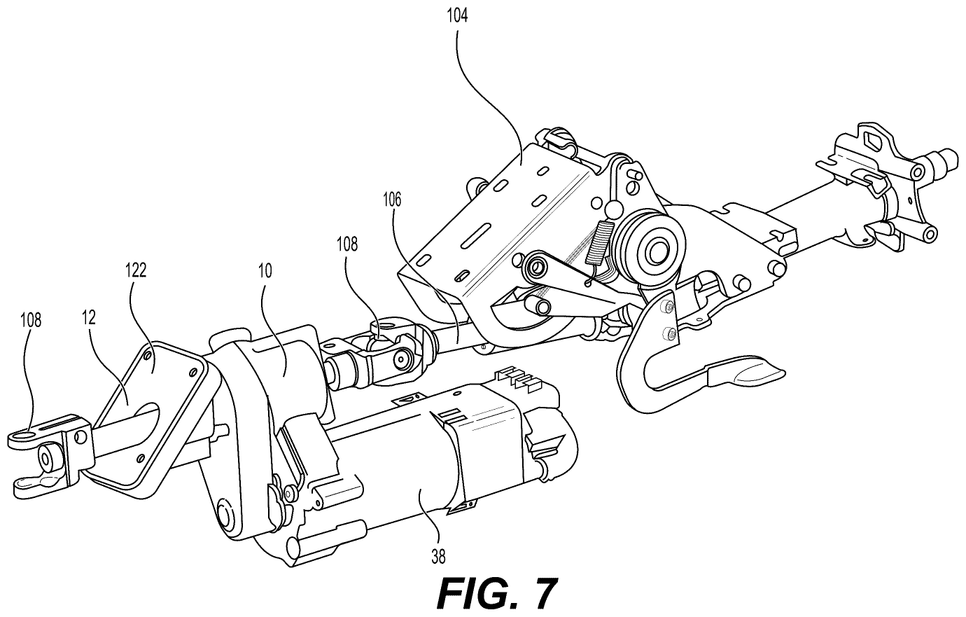

FIG. 6-12B show the details of such an arrangement. As shown in FIG. 6, vehicle 14 may include a steering wheel 100 mounted to a steering column 102 and connected to a primary shaft 106. The primary shaft 106 and steering wheel 100 may be mounted to a column assembly 104 (which is shown in more detail in FIG. 7). After column assembly 104, primary shaft 106 may be connected (e.g., via a universal joint 108) to steering shaft 12. Rotation of steering shaft 12 may then be controlled by system 10, as discussed herein. A firewall mount 122 can be positioned around steering shaft 12 so as to facilitate connection of system 10 to the firewall 110 of vehicle 14. After the firewall 110, steering shaft 12 is connected (e.g., via a universal joint 108) to a secondary shaft 114, which is in turn connected to steering gear 116. Inputs into steering gear 116 from secondary shaft 114 may then be used to control steering of the steering wheels of vehicle 14 (e.g., via sector shaft 118).

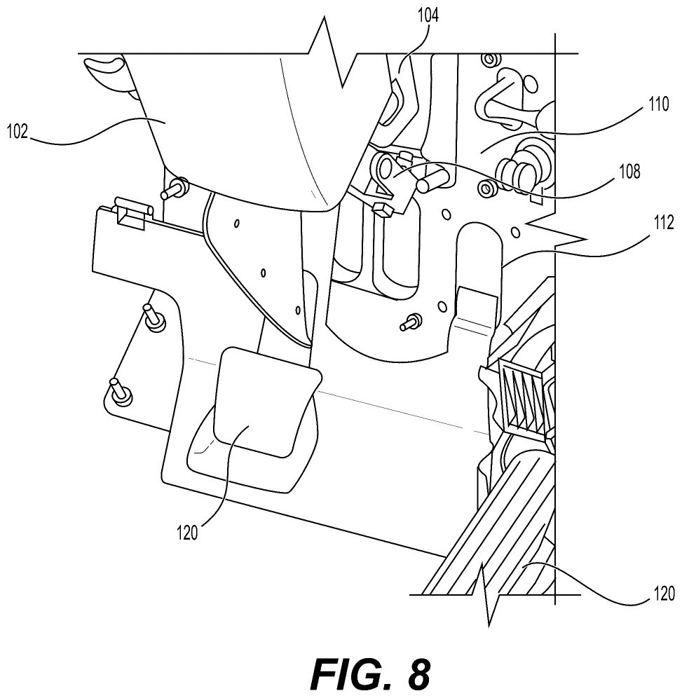

FIG. 8 shows a firewall pass-through 112 in firewall 110 where the firewall mount 122 may be mounted. As shown, there is limited room between steering column 102 and the firewall 110 (e.g., due to the existence of pedals 120) in which to install an electric motor 38 to implement ADAS functions. These are the type of packaging constraints that system 10 is able to satisfy.

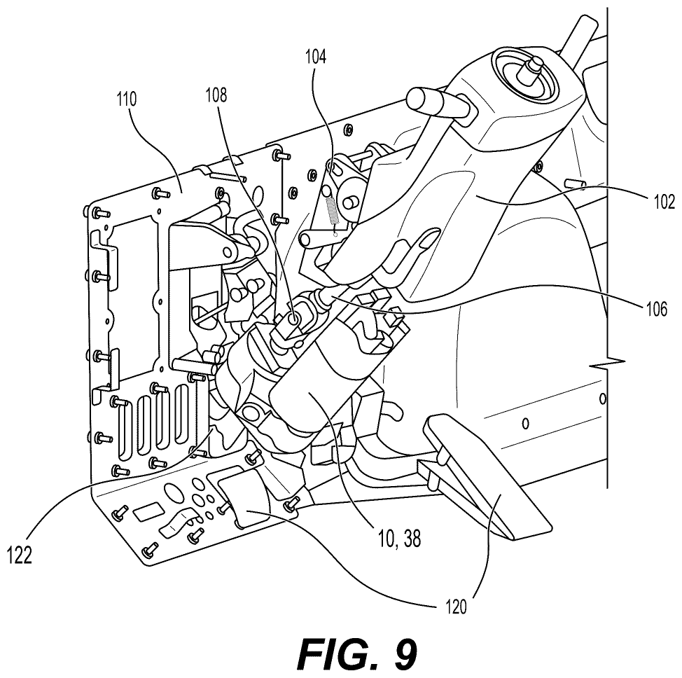

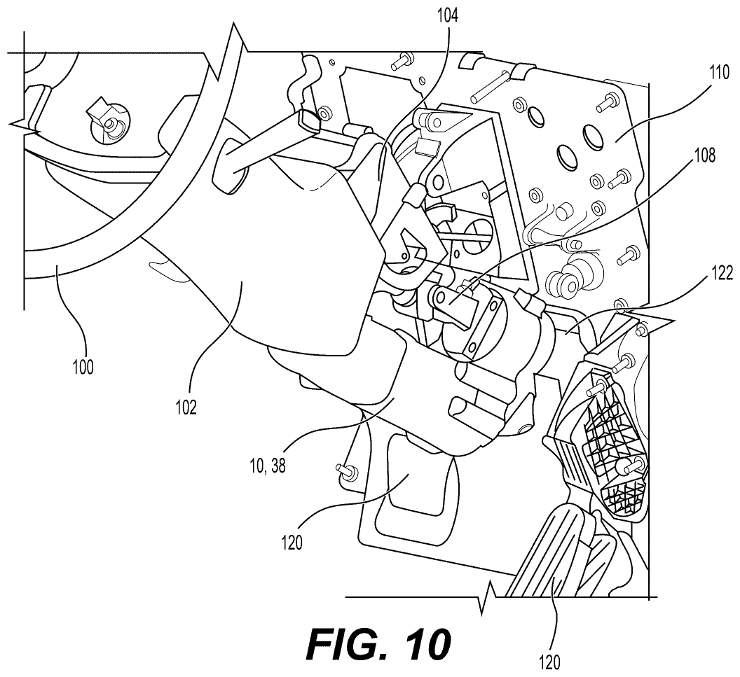

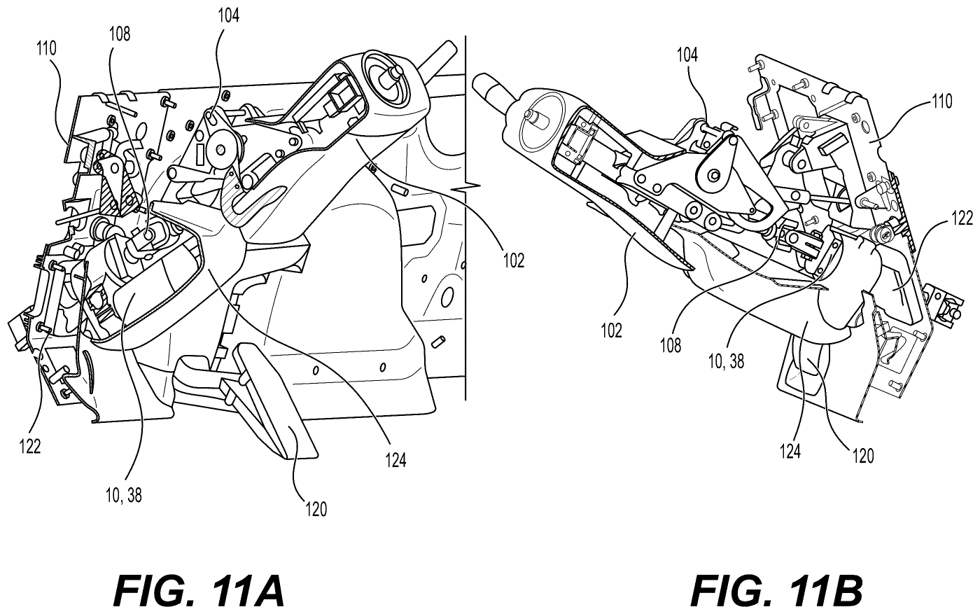

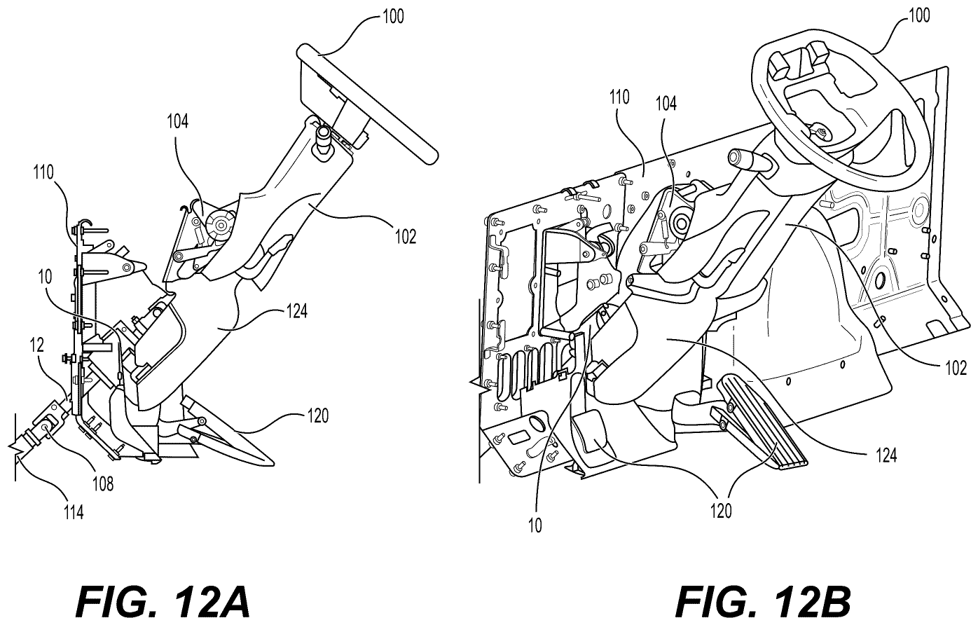

FIG. 9-10 show system 10 mounted to firewall 110, with column assembly 104 in position within steering column 102. As shown in FIG. 11A-12B, a covering 124 may be fitted over system 10.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

10 System
12 Steering shaft
14 Vehicle
16 Planetary gear set
18 Sun gear
20 Ring gear
22 Planetary carrier
24 Planetary gears
26 Planetary carrier output shaft
28 Belt drive system
30 Planetary carrier output shaft pulley
32 Steering shaft pulley
34 Pulley belt
36 Output shaft
38 Electric motor
40 Enclosure
42 Enclosure fastening guides
44 Fasteners
46 Electric motor fastener guides
48 Sun gear teeth
50 Planetary gear teeth
52 Ring gear teeth
100 Steering wheel
102 Steering column
104 Column assembly
106 Primary shaft
108 Universal joint
110 Firewall
112 Firewall pass-through
114 Secondary shaft
116 Steering gear
118 Sector shaft
120 Pedals
122 Firewall mount
124 Covering
L Longitudinal direction
R Radial direction
φ₁₆ Planetary gear set ratio
φ₂₈ Belt drive system ratio
φ₁₀ System ratio
D₃₀ Planetary carrier output shaft pulley diameter
D₃₂ Steering shaft pulley diameter
θ₁₂ Rotation of steering shaft 12
θ₁₈ Rotation of sun gear 18
θ₂₂ Rotation of planetary carrier 22
θ₂₄ Rotation of planetary gears 24
θ₃₀ Rotation of planetary carrier output shaft pulley 30
θ₃₂ Rotation of steering shaft pulley 32
τ₃₆ Output shaft torque
τ₁₂ Steering shaft torque
M₃₄ Movement of pulley belt 34

What is claimed is:

1. A system for rotating a steering shaft of a vehicle, the steering shaft extending in a longitudinal direction, the system comprising:
a planetary gear set comprising:
a sun gear,
a ring gear disposed radially outward in a radial direction with respect to the sun gear, and
a planetary carrier comprising a plurality of planetary gears and a planetary carrier output shaft, each planetary gear of the plurality of planetary gears being rotatable within the planetary carrier, in radially outward rotating engagement with the ring gear, and in radially inward rotating engagement with the sun gear; and
a belt drive system comprising:
a planetary carrier output shaft pulley concentrically disposed on the planetary carrier output shaft,
a steering shaft pulley disposed radially adjacent to the planetary carrier output shaft pulley, and
a pulley belt disposed at least partially around the planetary carrier output shaft pulley and at least partially around the steering shaft pulley,
wherein the steering shaft pulley is concentrically disposable on the steering shaft.

2. The system of claim 1, wherein the planetary gear set has a planetary gear set ratio of approximately 6:1.

3. The system of claim 1, wherein the belt drive system has a belt drive system ratio of approximately 3:1.

4. The system of claim 1, wherein the plurality of planetary gears comprises three planetary gears.

5. The system of claim 1, wherein the planetary gear set has a planetary gear set ratio of approximately 6:1 and the belt drive system has a belt drive system ratio of approximately 3:1 such that a system ratio of the system is approximately 18:1.

6. The system of claim 1, wherein a planetary carrier output shaft pulley diameter of the planetary carrier output shaft pulley is less than a steering shaft pulley diameter of the steering shaft pulley.

7. The system of claim 1, wherein a rotation of the sun gear is configured to rotate the plurality of planetary gears,
wherein a rotation of the plurality of planetary gears is configured to rotate the planetary carrier output shaft pulley, and
wherein a rotation of the planetary carrier output shaft pulley is configured to rotate the steering shaft pulley.

8. The system of claim 1, wherein the sun gear comprises an output shaft of an electric motor.

9. The system of claim 1, further comprising:
an electric motor having an output shaft,
wherein the sun gear comprises the output shaft.

10. The system of claim 9, wherein the output shaft is parallel with the steering shaft.

11. The system of claim 9, further comprising:
an enclosure comprising a plurality of enclosure fastening guides; and
a plurality of fasteners,
wherein the electric motor comprises a plurality of electric motor fastener guides that align with the plurality of enclosure fastening guides, and
wherein one fastener of the plurality of fasteners is disposed in a respective enclosure fastening guide of the plurality of enclosure fastening guides and a respective electric motor fastener guide of the plurality of electric motor fastener guides.

12. The system of claim 1, wherein the sun gear comprises a plurality of sun gear teeth,
wherein each planetary gear of the plurality of planetary gears comprises a plurality of planetary gear teeth, at least some planetary gear teeth of the plurality of planetary gear teeth of each planetary gear being in rotating engagement with at least some sun gear teeth of the plurality of sun gear teeth, and
wherein the ring gear comprises a plurality of ring gear teeth, at least some planetary gear teeth of the plurality of planetary gear teeth of each planetary gear being in rotating engagement with at least some ring gear teeth of the plurality of ring gear teeth.

13. A method of applying a steering shaft torque to a steering shaft of a vehicle, the method comprising:
generating an output shaft torque at an output shaft of an electric motor;
rotating, with the output shaft torque, a plurality of planetary gears of a planetary carrier, the planetary carrier comprising a planetary carrier output shaft pulley, with a pulley belt being disposed at least partially around the planetary carrier output shaft pulley;
rotating the planetary carrier within a ring gear through rotating engagement between the plurality of planetary gears and the ring gear so as to rotate the planetary carrier output shaft pulley and generate a movement of the pulley belt; and
rotating a steering shaft pulley disposed on the steering shaft through the movement of the pulley belt so as to generate the steering shaft torque.

14. The method of claim 13, wherein a planetary gear set ratio of the output shaft, the plurality of planetary gears, and the ring gear is approximately 6:1

15. The method of claim 13, wherein a belt drive system ratio of the planetary carrier output shaft pulley and the steering shaft pulley is approximately 3:1.

16. The method of claim 13, wherein the plurality of planetary gears comprises three planetary gears.

17. The method of claim 13, wherein a planetary carrier output shaft pulley diameter of the planetary carrier output shaft pulley is less than a steering shaft pulley diameter of the steering shaft pulley.

18. The method of claim 13, wherein the output shaft is parallel with the steering shaft.

19. The method of claim 13, wherein the planetary carrier output shaft pulley is disposed on a planetary carrier output shaft of the planetary carrier.

20. The method of claim 13, wherein the steering shaft torque ranges from 10 N·m to 20 N·m.
